(19) United States
(12) Patent Application Publication
(10) Pub. No.: US 2020/0262971 A1
(43) Pub. Date: Aug. 20, 2020

(54) TEREPHTHALATE-CO-4,4-BIBENZOATE POLYESTERS

(71) Applicants: ExxonMobil Chemical Patents Inc., Baytown, TX (US); Virginia Tech Intellectual Properties, Inc., Blacksburg, VA (US)

(72) Inventors: Haoyu Liu, Midlothian, VA (US); Ryan J. Mondschein, Blacksburg, VA (US); Ting Chen, Friendswood, TX (US); Timothy E. Long, Blacksburg, VA (US); S. Richard Turner, Blacksburg, VA (US)

(21) Appl. No.: 16/061,280

(22) PCT Filed: Oct. 7, 2016
(86) PCT No.: PCT/US16/56158

§ 371 Date: Jun. 11, 2018

Related U.S. Application Data
(60) Provisional application No. 62/271,075, filed on Dec. 22, 2015.

(51) Int. Cl. C08G 63/199; C08G 63/183; C08G 63/185

(52) U.S. Cl. CPC C08G 63/199; C08G 63/185; C08G 63/183

(57) ABSTRACT

Copolyesters are based on a diacid component containing terephthalate and 4,4′-biphenyl dicarboxylate or 3,4′-biphenyl dicarboxylate, and a diol component containing an alkylene diol, e.g., ethylene glycol or NPG, and an alicyclic polyhydroxyl compound, e.g., CHDM. The copolyesters may have a glass transition temperature more than 100° C. and mechanical, thermal and/or barrier characteristics at least comparable to some commercially available copolyesters. A method to control the morphology and properties of a copolyester involves contacting diacid and diol components in the presence of a catalyst, selecting proportions of terephthalic and 4,4′-biphenyl dicarboxylic or 3,4′-biphenyl dicarboxylic acids or ester producing equivalents thereof in the diacid component, and selecting the alkylene diol and proportions of the CHDM (or other alicyclic polyhydroxyl compound) and the alkylene diol in the diol component, to obtain the desired morphology and other properties.

### CROSS REFERENCE TO RELATED APPLICATIONS

This application is a section 371 national stage entry of PCT/US16/56158, 7 Oct. 2016, and claims the benefit of and priority to U.S. Ser. No. 62/271,075, 22 Dec. 2015, both of which are incorporated herein by reference.

### THE NAMES OF PARTIES TO A JOINT RESEARCH AGREEMENT

ExxonMobil Chemical Company, a division of ExxonMobil Corporation and Virginia Polytechnic Institute and State University.

### BACKGROUND

The industry is ever in search of new polymers with a high glass transition temperature (T_{g}) as well as impact strength and other properties suitable for high performance applications. For example, bisphenol-A based polycarbonate (BPA PC) exhibits T_{g} near 145° C., making it suitable for dishwasher cleaning and sterilization processes.

Polyesters based on diols and aromatic diacids, often called aromatic polyesters, are used in many industrial applications due to their low cost of production, easy processing, good barrier properties, and strong thermal and mechanical performances. Poly(ethylene terephthalate) (PET), poly(ethylene naphthalate) (PEN) and poly(1,4-cyclohexylenedimethylene terephthalate) (PCT), as well as PET modified with less than 50 mol % of 1,4-cyclohexanedimethanol (CHDM or, as polymerized, 1,4-cyclohexylenedimethylene) (PETG) and PCT modified with less than 50 mol % ethylene glycol (PCTG), are examples of such polyesters. Amorphous versus semicrystalline morphology, glass transition temperature, crystallization temperature, melting temperature, melt stability, heat distortion temperature, tensile and flexural strength, tensile and flexural moduli, and extension to break (toughness), are examples of important properties.

Copolymers of terephthalate and a bibenzoate, e.g., 4,4′-biphenyl dicarboxylic acid or 3,4′-biphenyl dicarboxylic acid, with a diol such as ethylene glycol are known from Krigbaum et al., Journal of Polymer Science, Polym. Letters, 20, 109 (1982); U.S. Pat. No. 4,082,731; and WO 2015/112252. A semicrystalline copolyester can be obtained when the 4,4′-biphenyl dicarboxylic acid content is less than 30 mole percent or more than 50 mole percent. These semicrystalline copolyesters usually have lower glass transition temperatures than desired and/or poor tensile properties such as toughness for particular applications, and in addition have melting temperatures higher than desired for processing. When more 4,4′-biphenyl dicarboxylic acid is incorporated to improve tensile or other properties, the melting temperature is further increased.

The amorphous copolyesters of 4,4′-biphenyl dicarboxylic acid and terephthalate with ethylene glycol generally incorporate more terephthalate, and can have undesirably low glass transition temperatures and/or poor tensile properties such as toughness. When more 4,4′-biphenyl dicarboxylic acid is incorporated in an effort to elevate the glass transition temperature or improve other properties, the copolyester becomes semicrystalline.

The industry thus has one or more of the following needs: to improve control over the morphology of the copolyesters of bibenzoate with terephthalate and/or improve the properties of the copolyester; to increase the amount of 4,4′-biphenyl dicarboxylic acid that can be used in an amorphous copolyester; to lower the melting temperature of the semicrystalline copolyesters; to increase the glass transition temperature of the amorphous or semicrystalline copolyesters; and/or to improve the tensile or other properties of such amorphous or semicrystalline copolyesters.

There is also a need for new polyesters having a better balance of mechanical, thermal and/or barrier properties to replace polymers which have one or more drawbacks and/or for use in new and ever more demanding applications.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In accordance with embodiments of the invention, a copolyester comprises: a diol component comprising an alkylene diol, such as ethylene glycol, 1,3-propanediol, 1,4-butanediol, 1,6-hexanediol, and/or neopentyl glycol (NPG), and an alicyclic polyhydroxyl compound such as 1,4-cyclohexanedimethanol (CHDM); and a diacid component comprising terephthalate and a bibenzoate, such as 4,4′-biphenyl dicarboxylate or 3,4′-biphenyl dicarboxylate.

In accordance with some embodiments of the invention, the copolyester comprises: an essentially amorphous morphology; a diol component comprising from about 10 to 90 mole percent CHDM and from about 90 to 10 mole percent of an alkylene diol comprising ethylene glycol, 1,3-propanediol, 1,4-butanediol, 1,6-hexanediol, NPG, or a combination thereof, based on the total moles of the diol component in the polyester; a diacid component comprising from about 30 to 90 mole percent 4,4′-biphenyl dicarboxylate and from about 70 to 10 mole percent terephthalate, based on the total moles of the diacid component in the polyester; and a glass transition temperature (T_{g}) equal to or greater than 110° C., determined by differential scanning calorimetry (DSC) analysis from a second heating ramp at a heating rate of 10° C./min.

In accordance with some embodiments of the invention, the copolyester comprises: an semicrystalline morphology; a diol component comprising from about 10 to 90 mole percent CHDM and from about 90 to 10 mole percent of an alkylene diol comprising ethylene glycol, 1,3-propanediol, 1,4-butanediol, 1,6-hexanediol, NPG, or a combination thereof, based on the total moles of the diol component in the polyester; a diacid component comprising from about 50 to 90 mole percent 4,4′-biphenyl dicarboxylate or 3,4′-biphenyl dicarboxylate and from about 50 to 10 mole percent terephthalate, based on the total moles of the diacid component in the polyester; a glass transition temperature (T_{g}) equal to or greater than 110° C., determined by differential scanning calorimetry (DSC) analysis from a second heating ramp at a heating rate of 10° C./min; and a melting temperature of less than or equal to about 250° C., determined by differential scanning calorimetry (DSC) analysis from a second heating ramp at a heating rate of 10° C./min.

In accordance with embodiments of the invention, a method comprises: contacting (i) a diol component comprising CHDM and an alkylene diol selected from ethylene glycol, 1,3-propanediol, 1,4-butanediol, 1,6-hexanediol, NPG and combinations thereof, with (ii) a diacid component comprising 4,4′-biphenyl dicarboxylic acid or 3,4′-biphenyl dicarboxylic acid, or ester producing equivalent thereof and terephthalic acid or ester producing equivalent thereof, in the presence of (iii) a catalyst; and forming a copolyester comprising the alkylene diol, CHDM, 4,4′-biphenyl dicarboxylic acid or 3,4′-biphenyl dicarboxylic acid, and terephthalate. In accordance with embodiments of the invention, a method to control the morphology, glass transition temperature, melting temperature and/or toughness of a copolyester comprises: contacting (i) a diacid component comprising from about 10 to 90 mole percent 4,4′-biphenyl dicarboxylic acid or 3,4′-biphenyl dicarboxylic acid, or ester producing equivalent thereof, from about 90 to 10 mole percent terephthalic acid or ester producing equivalent thereof, based on the total moles of the diacid component in the copolyester, with (ii) a diol component comprising from about 10 to 90 mole percent CHDM and from about 10 to 90 mole percent alkylene diol comprising ethylene glycol, 1,3-propanediol, 1,4-butanediol, 1,6-hexanediol, NPG or the combination thereof, based on the total moles of the diol component in the copolyester, in the presence of (iii) a catalyst; and selecting a proportion of the CHDM in the diol component, a proportion of the 4,4′-biphenyl dicarboxylic acid or 3,4′-biphenyl dicarboxylic acid, or ester producing equivalent thereof in the diacid component, and a proportion of the multifunctional dicarboxylic acid or ester producing equivalent thereof in total repeating units, to produce a copolyester comprising: an essentially amorphous or a semicrystalline morphology; a glass transition temperature within a selected range equal to or greater than about 110° C., determined by differential scanning calorimetry (DSC) analysis from a second heating ramp at a heating rate of 10° C./min; and where the morphology is semicrystalline, a melting temperature less than about 240° C., determined by DSC analysis from a second heating ramp at a heating rate of 10° C./min.

### BRIEF DESCRIPTION OF THE DRAWINGS

FIG. 1 is a plot of glass transition temperature (T_{g}) as a function of 4,4′-biphenyl dicarboxylic acid or 3,4′-biphenyl dicarboxylic acid content and ethylene glycol according to embodiments of the invention;

FIG. 2 is a plot of melting temperature (Tₘ) as a function of 4,4′-biphenyl dicarboxylic acid or 3,4′-biphenyl dicarboxylic acid content showing semicrystalline and amorphous regions according to embodiments of the invention; and

FIG. 3 is a plot of T_{g} as a function of CHDM content in a T-55-4,4′BB-EG-y-CHDM system showing the amorphous composition range according to embodiments of the invention.

### DETAILED DESCRIPTION

Throughout the entire specification, including the claims, the following terms shall have the indicated meanings.

The term “and/or” refers to both the inclusive “and” case and the exclusive “or” case, and such terms are used herein for brevity. For example, a composition comprising “A and/or B” may comprise A alone, B alone, or both A and B.

The percentages of monomers are expressed herein as mole percent (mol %) based on the total moles of monomers present in the reference polymer or polymer component. All other percentages are expressed as weight percent (wt %), based on the total weight of the particular composition present, unless otherwise noted. Room temperature is 25° C.±2° C. and atmospheric pressure is 101.325 kPa unless otherwise noted.

The term “consisting essentially of” in reference to a composition is understood to mean that the composition can include additional compounds other than those specified, in such amounts to the extent that they do not substantially interfere with the essential function of the composition, or if no essential function is indicated, in any amount up to 5 percent by weight of the composition.

For purposes herein a “polymer” refers to a compound having two or more “mer” units (see below for polyester mer units), that is, a degree of polymerization of two or more, where the mer units can be of the same or different species. A “homopolymer” is a polymer having mer units or residues that are the same species. A “copolymer” is a polymer having two or more different species of mer units or residues. A “terpolymer” is a polymer having three different species of mer units. “Different” in reference to mer unit species indicates that the mer units differ from each other by at least one atom or are different isomerically. Unless otherwise indicated, reference to a polymer herein includes a copolymer, a terpolymer, or any polymer comprising a plurality of the same or different species of repeating units.

The term “polyester”, as used herein, refers to a polymer comprised of residues derived from one or more polyfunctional acid moieties, collectively referred to herein as the “diacid component”, in ester linkage with residues derived from one or more polyhydroxyl compounds, which may also be referred to herein as “polyols” and collectively as the “diol component”.

The term “repeating unit”, also referred to as the “mer” units, as used herein with reference to polyesters refers to an organic structure having a diacid component residue and a diol component residue bonded through a carbonyloxy group, i.e., an ester linkage. Reference to the equivalent terms “copolyesters” or “(co)polyesters” or “polyester copolymers” herein is to be understood to mean a polymer prepared by the reaction of two or more different diacid compounds or ester producing equivalents thereof that incorporate different diacid residues into the backbone, and/or two or more different diol compounds that incorporate different diol residues into the backbone, i.e., either one or both of the diacid and diol components incorporate a combination of different species into the polymer backbone.

As used herein, the prefixes di- and tri-generally refer to two and three, respectively, with the exception of diacid and diol components noted herein. Similarly, the prefix “poly-” generally refers to two or more, and the prefix “multi-” to three or more. The carboxylic acids and/or esters used to make the copolyesters, or the residues of which are present therein, are collectively referred to herein as the “diacid component”, including both difunctional and multifunctional species thereof, or simply as the “acid component”; and likewise the hydroxyl compounds used to make the copolyesters, or the residues of which are present therein, are collectively referred to herein as the “diol component”, including both difunctional and multifunctional species thereof, or simply as the hydroxyl or polyol component.

The polycarboxylic acid residues, e.g., the dicarboxylate mer units, may be derived from a polyfunctional acid monomer or an ester producing equivalent thereof. Examples of ester producing equivalents of polyfunctional acids include one or more corresponding acid halide(s), ester(s), salts, the anhydride, or mixtures thereof. As used herein, therefore, the term “diacid” is intended to include polycarboxylic acids and any derivative of a polycarboxylic acid, including its associated acid halides, esters, half-esters, salts, half-salts, anhydrides, mixed anhydrides, or mixtures thereof, capable of forming esters useful in a reaction process with a diol to make polyesters.

As used herein, a “branching agent” is a multifunctional compound that causes or promotes the formation of branches in the growth of the polyester chain. A branching agent can be, for example, either a diol component or a diacid component, or comprise a mixture of functionalities. Multifunctional polyol branching agents can include, for example, glycerol, trimethylolpropane, ditrimethylol propane, trimethylolethane, pentaerythrytol, dipentaerythrytol, glycerol and so on. Multifunctional acid component branching agents can include, for example, trimellitic and/or pyromellitic anhydrides or acids, etc. and their esters and ester producing equivalents thereof, and the like, in which the anhydride functional group(s) reacts to form two carboxylic acid groups. Furthermore, the term “branching agent” may include multifunctional compounds having a total number of mixed carboxylic acid and/or hydroxyl groups of three or more, e.g., two acid groups and one hydroxyl group, or one acid group and two hydroxyl groups, etc.

The term “residue”, as used herein, means the organic structure of the monomer in its as-polymerized form as incorporated into a polymer, e.g., through a polycondensation and/or an esterification or transesterification reaction from the corresponding monomer. Throughout the specification and claims, reference to the monomer(s) in the polymer is understood to mean the corresponding as-polymerized form or residue of the respective monomer. For purposes herein, it is to be understood that by reference to a copolyester comprising a diacid component and a diol component, the diacid and diol components are present in the polymer in the as-polymerized (as-condensed) form. For example, the diacid component is present in the polymer as dicarboxylate in alternating ester linkage with the diol component, yet the polyester may be described as being comprised of, for example, the dicarboxylic acid or dicarboxylic acid alkyl ester and diol, e.g., terephthalic acid-ethylene glycol polyester or dimethylterephthalate-ethylene glycol polyester, where it is understood the acid or methyl ester groups in the starting material are not present in the polyester.

Mole percentages of the diacid and diol components are expressed herein based on the total moles of the respective component, i.e., the copolyesters comprise 100 mole percent of the polyfunctional acid component and 100 mole percent of the polyfunctional hydroxyl component. Mole percentages of a branching agent are based on the total moles of repeating (ester-linked diacid-diol) units.

For purposes herein, an essentially amorphous polymer is defined as a polymer that does not exhibit a substantially crystalline melting point, Tm, i.e., no discernable heat of fusion or a heat of fusion less than 5 J/g, when determined by differential scanning calorimetry (DSC) analysis from the second heating ramp by heating of the sample at 10° C./min from 0° C. to 300° C. For purposes herein, in the absence of DSC analysis, an amorphous polymer is indicated if injection molding of the polymer produces an article which is essentially clear, wherein the injection molding process used is known to produce articles having cloudy or opaque character upon injection molding of a semi-crystalline polymer having similar properties to the amorphous polymer.

Conversely, a polymer exhibiting a crystalline melting point may be crystalline or, as is more common for polyesters, semicrystalline. A semicrystalline polymer contains at least 5 weight percent of a region or fraction having a crystalline morphology and at least 5 weight percent of a region or fraction having an amorphous morphology.

For purposes herein, the melting temperature, crystallization temperature, glass transition temperature, etc., are determined by DSC analysis from the second heating ramp by heating of the sample at 10° C./min from 0° C. to 300° C. The melting, crystallization, and glass transition temperatures are measured as the midpoint of the respective endotherm or exotherm in the second heating ramp.

Unless indicated otherwise, inherent viscosity is determined in 0.5% (g/dL) dichloroacetic acid solution at 25° C. by means of a CANNON TYPE B glass capillary viscometer, adapted from ASTM method D4603. Inherent viscosity at 0.5 g/dL dichloroacetic acid solution was used to calculate intrinsic viscosity according to the method outlined in Ma et al., “Fiber Spinning, Structure, and Properties of Poly(ethylene terephthalate-co-4, 4′-bibenzoate) Copolyesters”, Macromolecules, 2002, 35, 5123-5130. Inherent viscosity (ηᵢₙₕ) is calculated as the ratio of the natural logarithm of the relative viscosity to the mass concentration of the polymer according to the equation (A):

$${η}_{inh} = \frac{ln {η}_{rel}}{c} \qquad ( A )$$

where c is the mass concentration of the polymer (g/dL) and ηᵣₑₗ is the relative viscosity, which is determined according to the equation (B):

$${η}_{rel} \frac{η}{{η}_{0}} \qquad ( B )$$

where η is the viscosity of the solution and η₀ is the viscosity of the neat solvent. Unless otherwise specified, inherent viscosity is expressed as dL/g.

It is to be understood that for purposes herein, a polymer referred to as a “bibenzoate” comprises a diacid component comprising residues derived from a biphenyl dicarboxylic acid or ester producing equivalent thereof, such as, for example, 4,4′-biphenyl dicarboxylic acid or ester producing equivalent thereof as disclosed herein, 3,4′-biphenyl dicarboxylic acid or ester producing equivalent thereof as disclosed herein, or the combination thereof.

The difunctional hydroxyl compound can be a dihydric alcohol such as, for example, glycols and diols. The term “glycol” as used in this application includes, but is not limited to, diols, glycols, and/or multifunctional hydroxyl compounds. In embodiments, the difunctional hydroxyl compound may be an alicyclic or aromatic nucleus bearing 2 hydroxyl substituents such as, for example, 2,2′,4,4′-tetramethyl-1,3-cyclobutanediol (TMCBD), 1,4-cyclohexanedimethanol CHDM), hydroquinone bis(2-hydroxyethyl) ether, or the like.

For purposes herein, a polymer is “essentially free of crosslinking” if it contains no more than 5 weight percent gel by weight of the polymer. In all embodiments and aspects herein, the polyester may be essentially free of crosslinking.

The following abbreviations are used herein: ASTM is ASTM International, formerly the American Society for Testing and Materials; 3,4′BB is dimethyl 3,4′-biphenyldicarboxylate; 4,4′BB is dimethyl 4,4′-biphenyldicarboxylate; BPA is bisphenol A; CHDM is 1,4-cyclohexanedimethanol, sometimes referred to as 1,4-cyclohexylenedimethylene in the as-polymerized form; DCA is dichloroacetic acid; DEG is diethylene glycol; DMA is dynamic mechanical analysis; DMT is dimethyl terephthalate; DSC is differential scanning calorimetry; EG is ethylene glycol; GPC is gel permeation chromatograph; HDT is heat distortion temperature; NPG is neopentyl glycol, 2,2-dimethyl-1,3-propanediol; PC is bisphenol A polycarbonate; PCT is poly(1,4-cyclohexylenedimethylene terephthalate); PCTG is PCT modified with less than 50 mol % ethylene glycol; PEN is polyethylene naphthalate; PET is polyethylene terephthalate; PETG is PET modified with less than 50 mol % of CHDM; TFA is trifluoroacetic acid; TFA-d is deuterated trifluoroacetic acid; TGA is thermogravimetric analysis; THF is tetrahydrofuran; TMA is trimellitic anhydride; TMCBD is 2,2′,4,4′-tetramethyl-1,3-cyclobutanediol; DMT is dimethyl terephthalate.

Polyesters according to embodiments herein may be prepared from a diacid component and a diol component, which react in substantially equal molar proportions and are incorporated into the polyester polymer as their corresponding residues. The polyesters useful in the present invention, therefore, can contain substantially equal molar proportions of acid residues (100 mol %) and diol residues (100 mol %) such that the total moles of repeating units are equal to 100 mole percent. The mole percentages provided in the present invention, therefore, may be based on the total moles of acid residues, the total moles of diol residues, or the total moles of repeating units unless otherwise indicated.

According to some embodiments of the present invention, a copolyester comprises: a diol component comprising an alicyclic polyhydroxyl compound and an alkylene diol, e.g., from about 1 to 99 mole percent of the alicyclic polyhydroxyl compound and from about 99 to 1 mole percent of the alkylene diol, based on the total moles of the diol component; a diacid component comprising terephthalate (derived from the diacid or ester producing equivalent thereof) and 4,4′-biphenyl dicarboxylic acid (derived from the diacid or ester producing equivalent thereof), or 3,4′-biphenyl dicarboxylic acid (derived from the diacid or ester producing equivalent thereof), e.g., from about 1 to 99 mole percent terephthalate and from about 99 to 1 mole percent 4,4′-biphenyl dicarboxylic acid or 3,4′-biphenyl dicarboxylic acid, based on the total moles of the diacid component in the copolyester. The morphology of the copolyesters is essentially amorphous in some embodiments and semicrystalline in others. In some embodiments, the alicyclic polyhydroxyl compound comprises CHDM and/or the alkylene diol is selected from ethylene glycol, 1,3-propanediol, 1,4-butanediol, 1,6-hexanediol, NPG, and combinations thereof. In embodiments of the invention, the diol component consists essentially of CHDM and the alkylene diol, and/or the diacid component consists essentially of 4,4′-biphenyl dicarboxylic acid and terephthalate or 3,4′-biphenyl dicarboxylic acid and terephthalate.

In embodiments, the diacid component of the copolyester comprises a lower limit for 4,4′-biphenyl dicarboxylic acid or 3,4′-biphenyl dicarboxylic acid, selected from about 1, or 10, or 20, or 30, or 40, or 50, or 60, or 65, or 70, or 75, or 80 mole percent, based on the total moles of the diacid component; up to any higher limit of about 99, or 90, or 85, or 75, or 70, or 65, or 60, or 55, or 50, or 45, or 40, or 30, or 25, or 20 mole percent, preferably with the balance of the diacid component being terephthalic acid. For example, the diacid component may comprise from about 10 to 90 mole percent 4,4′-biphenyl dicarboxylic acid or 3,4′-biphenyl dicarboxylic acid, and from about 90 to 10 mole percent terephthalic acid; or from about 30 to 90 mole percent 4,4′-biphenyl dicarboxylic acid or 3,4′-biphenyl dicarboxylic acid and from about 70 to 10 mole percent terephthalic acid, or the like; all based on the total moles of the diacid component.

In some embodiments where the copolyester is essentially amorphous, depending on the diol composition the diacid may comprise from about 30 to 90 mole percent 4,4′-biphenyl dicarboxylic acid or 3,4′-biphenyl dicarboxylic acid, and from about 70 to 10 mole percent terephthalic acid; or from about 50 to 75 mole percent 4,4′-biphenyl dicarboxylic acid or 3,4′-biphenyl dicarboxylic acid, and from about 50 to 25 mole percent terephthalic acid; or from about 50 to 60 mole percent 4,4′-biphenyl dicarboxylic acid or 3,4′-biphenyl dicarboxylic acid, and from about 50 to 40 mole percent terephthalic acid; or from about 60 to 70 mole percent 4,4′-biphenyl dicarboxylic acid or 3,4′-biphenyl dicarboxylic acid, and from about 40 to 30 mole percent terephthalic acid; or the like; all based on the total moles in the diacid component.

In some embodiments where the copolyester is semicrystalline, depending on the diol component, the diacid may comprise from about 50 to 90 mole percent 4,4′-biphenyl dicarboxylic acid or 3,4′-biphenyl dicarboxylic acid, and from about 50 to 10 mole percent terephthalic acid; or from about 60 to 90 mole percent 4,4′-biphenyl dicarboxylic acid or 3,4′-biphenyl dicarboxylic acid, and from about 40 to 10 mole percent terephthalic acid; or from about 65 to 85 mole percent4,4′-biphenyl dicarboxylic acid or 3,4′-biphenyl dicarboxylic acid, and from about 35 to 15 mole percent terephthalic acid; or from about 60 to 80 mole percent4,4′-biphenyl dicarboxylic acid or 3,4′-biphenyl dicarboxylic acid, and from about 40 to 20 mole percent terephthalic acid; or from about 65 to 75 mole percent 4,4′-biphenyl dicarboxylic acid or 3,4′-biphenyl dicarboxylic acid, and from about 35 to 25 mole percent terephthalic acid; or from about 60 to 70 mole percent 4,4′-biphenyl dicarboxylic acid or 3,4′-biphenyl dicarboxylic acid, and from about 40 to 30 mole percent terephthalic acid; or the like; all based on the total moles in the diacid component.

In some embodiments of the invention, the diacid component comprises, consists essentially of, or consists of 4,4′-biphenyl dicarboxylic acid and terephthalic acid, and/or the total moles of 4,4′-biphenyl dicarboxylic acid and terephthalic acid in any of the ranges provided herein total 100 mole percent.

In some embodiments of the invention, the diacid component comprises, consists essentially of, or consists of 3,4′-biphenyl dicarboxylic acid and terephthalic acid, and/or the total moles of 3,4′-biphenyl dicarboxylic acid and terephthalic acid in any of the ranges provided herein total 100 mole percent.

In some embodiments, the diacid component in the copolyester may comprise additional polyfunctional acids in amounts as desired, such as, for example, from about 0.1 to 90 mole percent, preferably 0.1 to 5 mole percent or less than 1 mole percent, of one or more of another bibenzoic acid (3,4′-biphenyl dicarboxylic acid or 4,4′biphenyl dicarboxylic acid as the case may be), isophthalic acid, phthalic acid, naphthalic acid, e.g., 1,5-naphthalenedicarboxylic acid, 2,6-naphthalenedicarboxylic acid, or 2,7-naphthalenedicarboxylic acid, or the like, derived from the corresponding acids, esters or any ester producing equivalents thereof.

In some embodiments of the invention, the diol component comprises aliphatic polyols, especially alkylene diols, having 2 to 20 carbon atoms (preferably from 2 to 10 or from 2 to 5 carbon atoms), alicyclic polyols having 3 to 20 carbon atoms, aromatic polyols having 6 to 20 carbon atoms, and so on, where any diol component constituent may be present in the copolyester, for example, in an amount equal to or greater than about 1 mole percent, based on the total moles of the diol component in the copolyester. In embodiments, the diol component comprises ethylene glycol, neopentylglycol, 1,2-propanediol, 1,3-propanediol, 1,4-butanediol, 1,5-pentanediol, 1,6-hexanediol, isosorbide, isoidide, isomannide, 1,3-cyclohexanedimethanol, CHDM, p-xylene glycol, or a combination thereof. In embodiments, the diol component of the polyester copolymer comprises CHDM and an alkylene diol having 2 to 20 carbon atoms, preferably from 2 to 10 or from 2 to 5 carbon atoms, preferably ethylene glycol, 1,3-propanediol, 1,4-butanediol, 1,6-hexanediol, neopentylglycol, or a combination thereof.

In some embodiments of the invention, the diol component comprises an alicyclic polyol, such as, for example, a polyol having 4 to 20 carbon atoms and containing one or more 4- to 7-member aliphatic rings, e.g., a cyclohexanedimethanol such as 1,3-cyclohexanedimethanol and/or CHDM; 2,2,4,4-tetramethyl-1,3-cyclobutanediol; and so on. In some embodiments, the alicyclic diol, e.g., CHDM, is present in the copolyester an amount effective to control crystallinity, mechanical properties, the glass transition temperature Tg, and/or the melting temperature Tm, e.g., equal to or greater than about 5 mole percent, or equal to or greater than about 10 mole percent of the diol component, up to about 90 mole percent, based on the total moles of the diol component in the copolyester.

In some embodiments of the invention, the diol component of the copolyester comprises, or consists essentially of, CHDM and alkylene diol, especially ethylene glycol (EG), and/or the total moles of CHDM and alkylene diol total 100 mole percent. In general, higher levels of CHDM relative to alkylene diol, especially EG, can increase Tg, reduce Tm, shift the morphology toward amorphous (reduce crystallinity), and/or increase toughness (elongation to break), whereas higher levels of EG or other alkylene diol generally have the opposite effect for polyester property control. In embodiments, the diol component of the copolyester comprises a lower limit for CHDM selected from about 1, or 10, or 15, or 20, or 25, or 30, or 35, or 40, or 50, or 55, or 60, or 65, or 70, or 75 mole percent, based on the total moles of the diol component; up to any higher limit of about 99, or 90, or 85, or 80, or 75, or 70, or 65, or 60, or 50 mole percent, preferably with the balance of the diol component being alkylene diol, preferably EG, 1,3-propanediol, 1,4-butanediol, 1,6-hexanediol, NPG or a combination thereof, especially EG and/or NPG.

For example, the diol may comprise from about 10 to 90 mole percent CHDM, and from about 90 to 10 mole percent EG (or other alkylene diol); or from about 20 to 80 mole percent CHDM, and from about 80 to 20 mole percent EG (or other alkylene diol); or from about 30 to 70 mole percent CHDM, and from about 70 to 30 mole percent EG (or other alkylene diol); or from about 35 to 65 mole percent CHDM, and from about 65 to 35 mole percent EG (or other alkylene diol); or from about 20 to 50 mole percent CHDM, and from about 80 to 50 mole percent EG (or other alkylene diol); or from about 30 to 40 mole percent CHDM, and from about 70 to 60 mole percent EG (or other alkylene diol); or from about 20 to 50 mole percent EG (or other alkylene diol), and from about 80 to 50 mole percent CHDM; or from about 30 to 40 mole percent EG (or other alkylene diol), and from about 70 to 60 mole percent CHDM; or the like; all based on the total moles in the diol component.

In some embodiments of the invention, the diol component of the copolyester comprises or consists essentially of alkylene diol selected from ethylene glycol (EG) and neopentyl glycol (NPG), and CHDM, where the CHDM is present in the copolyester in the amounts set out above, and wherein the alkylene diol(s) (e.g., NPG alone or NPG and EG together) are present in the amounts set out above for the EG, e.g., the diol component of the copolyester comprises a lower limit for NPG (or a combination of NPG and EG) selected from about 1, or 10, or 15, or 20, or 25, or 30, or 35, or 40, or 50, or 55, or 60, or 65, or 70, or 75 mole percent, based on the total moles of the diol component; up to any higher limit of about 99, or 90, or 85, or 80, or 75, or 70, or 65, or 60, or 50 mole percent, preferably with the balance of the diol component being CHDM. Where EG and NPG are both present they may be in a molar ratio of EG:NPG of from 1:20 to 20:1.

In some embodiments of the invention, the polymer may further comprise a branching agent as defined above, e.g., a multifunctional hydroxyl or carboxylic acid compound, preferably a polyfunctional acid compound such as trimellitic or pyromellitic anhydride. In some embodiments of the invention, the branching agent is present in an amount effective to reduce the crystallinity and/or the rate of crystallization, and/or up to an amount that does not result in significant crosslinking, e.g., the copolyester can be essentially free of crosslinking or gel formation. In embodiments, the copolymer comprises an amount of trimellitic anhydride suitable to form a measurable amount of long chain branching in the copolymer, as determinable by DSC analysis at a heating rate of 10° C./min, ¹H NMR analysis, or ¹³C NMR analysis. In the event of conflict, DSC shall control, then ¹H NMR.

In some embodiments of the invention, the copolyester comprises equal to or greater than about 0.001 mole percent of the branching agent (e.g., a tricarboxylic acid moiety or ester producing derivative thereof), based on the total moles of repeating units in the copolyester. For example, the branching agent (e.g., trimellitic anhydride) may be present at from about 0.001 to 1 mole percent, or from about 0.005 to 0.5 mole percent, or from about 0.01 to 0.5 mole percent, or from about 0.02 to 0.3 mole percent, or from about 0.05 to 0.3 mole percent, or from about 0.1 to 0.3 mole percent, based on the total moles of repeating units in the copolyester. In some embodiments, the diacid component of the polymer consists essentially of 4,4′-biphenyl dicarboxylic acid or 3,4′-biphenyl dicarboxylic acid, terephthalic acid, and trimellitic anhydride.

In some embodiments of the invention, the polymer comprises a number average molecular weight Mn (g/mol) equal to or greater than 5,000 or equal to or greater than 8,000, or equal to or greater than 10,000, or equal to or greater than 12,000, or equal to or greater than 15,000, or equal to or greater than 20,000, or equal to or greater than 30,000, or equal to or greater than 40,000, or equal to or greater than 50,000; and/or a polydispersity of greater than 1.75 up to 3.5, or from 1.8 up to 3, or from 1.8 to 2.5, or from 1.9 to 2.5, or about 2.0, where Mn and polydispersity are determined by GPC or calculated from the inherent viscosity. In the event of conflict, inherent viscosity shall control.

In some embodiments of the invention, the polymer comprises an inherent viscosity equal to or greater than about 0.5 dL/g, or equal to or greater than 0.7 dug, or equal to or greater than 0.8 dL/g; and/or less than or equal to about 1 dL/g, or less than or equal to about 0.9 dL/g; measured at a temperature of 25° C. in dichloroacetic acid.

In embodiments, the polymer comprises a glass transition temperature equal to or greater than about 95° C., or equal to or greater than about 100° C., or equal to or greater than about 105° C., or equal to or greater than about 110° C., or equal to or greater than 112° C., or equal to or greater than 114° C., or equal to or greater than about 115° C., or equal to or greater than 116° C., or equal to or greater than 118° C., or equal to or greater than about 120° C., or equal to or greater than about 125° C., or equal to or greater than 130° C., or up to about 135° C. or greater, determined by DSC analysis from a second heating ramp at a heating rate of 10° C./min.

In some embodiments, the copolyester comprises an oxygen permeability coefficient less than or equal to about 4, or less than or equal to about 2.5, or less than or equal to about 2, or less than or equal to about 1.5, or less than or equal to about 1, or less than or equal to about 0.8, or less than or equal to about 0.7, or less than or equal to about 0.6, or less than or equal to about 0.5, or less than or equal to about 0.4, or less than or equal to about 0.3 cm³-cm/m²-atm-day, determined at 23° C.

In some embodiments, the copolyester comprises: an elongation at break of equal to or greater than about 70 percent, determined according to ASTM D638; a tensile strength of equal to or greater than about 50 MPa determined according to ASTM D638; a tensile modulus of equal to or greater than about 1500 MPa, determined according to ASTM D638; a flexural strength of equal to or greater than about 75 MPa, determined according to ASTM D790; a flexural modulus of equal to or greater than about 1500 MPa, preferably equal to or greater than about 2000 MPa, determined according to ASTM D790; a heat distortion temperature at 455 kPa of equal to or greater than about 70° C., determined according to ASTM D648; a heat distortion temperature at 1.82 MPa of equal to or greater than about 60° C., determined according to ASTM D648; or a combination thereof.

In some embodiments of the invention the copolyester comprises a semicrystalline morphology. In embodiments, the polymer comprises an amount of 4,4′-biphenyl dicarboxylic acid (or 3,4′-biphenyl carboxylic acid) relative to terephthalate and/or ethylene glycol (or other alkylene diol) relative to CHDM sufficient to produce a melting point peak, a crystallization point peak, or both determined by DSC analysis.

In some additional or alternative embodiments, the polyester copolymer comprises up to about 55 weight percent crystallinity, or up to about 35 weight percent crystallinity, or less than or equal to 30 weight percent crystallinity, or less than or equal to about 20 weight percent crystallinity, or less than or equal to about 10 weight percent crystallinity, or less than or equal to about 5 weight percent crystallinity, or less than or equal to about 1 weight percent crystallinity, determined by DSC analysis. In some embodiments, the polymer is amorphous, e.g., the polymer does not comprise a measurable crystallization temperature Tc and/or does not comprise a discernable melting temperature Tm, as determined by DSC.

In embodiments, the polymer comprises a melting temperature Tm of less than or equal to about 280° C., or less than or equal to about 275° C., or less than or equal to about 270° C., or less than or equal to about 260° C., or less than or equal to about 250° C., or less than or equal to about 240° C., or less than or equal to about 230° C., or less than or equal to about 220° C., or less than or equal to about 210° C., determined by DSC analysis from a second heating ramp at a heating rate of 10° C./min.

In some embodiments, the Tm is less than the lowest Tm of the corresponding copolyesters made with a single diol, preferably at least 20° C. less or at least 30° C. less than either of the corresponding single-diol copolyesters having the same diacid content. For example, if T-55-4,4′BB-EG and T-55-4,4′BB-CHDM have Tm of 262° C. and 245° C., respectively, then the Tm of the inventive semicrystalline T-55-4,4′BB-EG-y-CHDM has a Tm less than 245° C., the lower of the two corresponding single diol copolyesters.

Some inventive embodiments of the polyester copolymer comprise a thermal degradation temperature (Td) of equal to or greater than about 300° C., or equal to or greater than about 350° C., or equal to or greater than about 375° C., or equal to or greater than about 400° C., at 5 weight percent as determined according to ASTM D3850 by thermogravimetric analysis.

In some embodiments of the invention, the polymer comprises an elongation at break of equal to or greater than about 20, or 35, or 50, or 65, or 70, or 75, or 85, or 90, or 95, or 100, or 110, or 125, or 150 percent, determined according to ASTM D638.

In some embodiments of the invention, the polymer comprises a tensile strength of equal to or greater than about 45 MPa, or equal to or greater than about 50 MPa, or equal to or greater than about 60 MPa, or equal to or greater than about 80 MPa, or equal to or greater than about 100 MPa, determined according to ASTM D638.

In some embodiments of the invention, the polymer comprises a tensile modulus (without extensometer) of equal to or greater than about 1200 MPa, or equal to or greater than about 1300 MPa, or equal to or greater than about 1400 MPa, or equal to or greater than about 1500 MPa, determined according to ASTM D638.

In some embodiments of the invention, the polymer comprises a flexural strength of equal to or greater than about 65 MPa, or equal to or greater than about 70 MPa, or equal to or greater than about 75 MPa, determined according to ASTM D638.

In some embodiments of the invention, the polymer comprises a flexural modulus of equal to or greater than about 1500 MPa, or equal to or greater than about 1800 MPa, or equal to or greater than about 2000 MPa, or equal to or greater than about 2200 MPa, equal to or greater than about 2400 MPa, determined according to ASTM D638.

The heat distortion temperature (HDT) is the temperature at which a sample deforms under a specified load of 455 kPa or 1.82 MPa, determined according to ASTM D648. In embodiments, the copolyester comprises an HDT at 455 kPa of equal to or greater than about 65° C., or equal to or greater than about 70° C., or equal to or greater than about 75° C., or equal to or greater than about 80° C., or equal to or greater than about 90° C., or equal to or greater than about 100° C., or equal to or greater than about 105° C., determined according to ASTM D648. In embodiments, the polyester copolymer comprises an HDT at 1.82 MPa of equal to or greater than about 60° C., or equal to or greater than about 65° C., or equal to or greater than about 70° C., or equal to or greater than about 75° C., or equal to or greater than about 80° C., or equal to or greater than about 90° C., determined according to ASTM D648.

In some embodiments of the invention, a copolyester comprises a diol component comprising an alkylene diol and an alicyclic polyhydroxyl compound; and a diacid component comprising terephthalate and 4,4′-biphenyl dicarboxylic acid.

In some embodiments the diol component comprises from about 10 to 90 mole percent CHDM, and from about 10 to 90 mole percent alkylene diol selected from the group consisting of ethylene glycol, 1,3-propanediol, 1,4-butanediol, 1,6-hexanediol, NPG, and the combination thereof, based on the total moles of the diol component in the polyester; and the diacid component comprises from about 10 to 90 mole percent 4,4′-biphenyl dicarboxylic acid and from about 10 to 90 mole percent terephthalic acid, based on the total moles of the diacid component in the copolyester.

In some embodiments, the copolyester further comprises an average number molecular weight of equal to or greater than about 5,000 g/mol and a polydispersity from about 1.75 to 3.5; and/or a glass transition temperature equal to or greater than about 105° C., determined by differential scanning calorimetry (DSC) analysis from a second heating ramp at a heating rate of 10° C./min; and/or an oxygen permeability less than or equal to about 4, or less than or equal to about 2.5, or less than or equal to about 2, or less than or equal to about 1.5, or less than or equal to about 1, or less than or equal to about 0.8, or less than or equal to about 0.7, or less than or equal to about 0.6, or less than or equal to about 0.5, or less than or equal to about 0.4, or less than or equal to about 0.3 cm³-cm/m²-atm-day.

In some embodiments, the copolyester comprises: an essentially amorphous morphology; a diol component comprising from about 10 to 90 mole percent CHDM and from about 90 to 10 mole percent of an alkylene diol comprising ethylene glycol, 1,3-propanediol, 1,4-butanediol, 1,6-hexanediol, NPG, or a combination thereof, based on the total moles of the diol component in the polyester; and a diacid component comprising from about 30 to 90 mole percent 4,4′-biphenyl dicarboxylic acid and from about 70 to 10 mole percent terephthalic acid, based on the total moles of the diacid component in the polyester; and a glass transition temperature equal to or greater than about 110° C. determined by differential scanning calorimetry (DSC) analysis from a second heating ramp at a heating rate of 10° C./min.

In some embodiments, the diacid component comprises from about 50 to 75 mole percent 4,4′-biphenyl dicarboxylic acid and from about 25 to 50 mole percent terephthalate, based on the total moles of the diacid component in the copolyester; and/or the diol component comprises from about 40 to 80 mole percent CHDM and from about 60 to 20 mole percent alkylene diol, based on the total moles of the diol component in the copolyester.

In some embodiments, the diol component comprises from about 50 to 75 mole percent CHDM and from about 50 to 25 mole percent NPG, based on the total moles of the diol component in the copolyester.

In some embodiments, the amorphous copolyester has a glass transition is equal to or greater than about 115° C.; and/or an elongation at break of equal to or greater than about 80 percent determined according to ASTM D638; and/or a tensile strength of equal to or greater than about 50 MPa determined according to ASTM D638; and/or a tensile modulus of equal to or greater than about 1500 MPa determined according to ASTM D638; and/or a flexural strength of equal to or greater than about 75 MPa, determined according to ASTM D790; and/or a flexural modulus of equal to or greater than about 2200 MPa, determined according to ASTM D790; and/or a heat distortion temperature at 455 kPa of equal to or greater than about 75° C., determined according to ASTM D648; and/or a heat distortion temperature at 1.82 MPa of equal to or greater than about 65° C., determined according to ASTM D648; and/or a combination thereof.

In some embodiments of the invention, a copolyester comprises a semicrystalline morphology; a diol component comprising from about 10 to 90 mole percent CHDM and from about 10 to 90 mole percent of an alkylene diol comprising ethylene glycol, 1,3-propanediol, 1,4-butanediol, 1,6-hexanediol, NPG, or a combination thereof, based on the total moles of the diol component in the polyester; a diacid component comprising from about 50 to 90 mole percent 4,4′ biphenyl dicarboxylic acid and from about 50 to 10 mole percent terephthalate, based on the total moles of the diacid component in the polyester; a glass transition temperature equal to or greater than about 110° C. determined by differential scanning calorimetry (DSC) analysis from a second heating ramp at a heating rate of 10° C./min; and a melting temperature of less than or equal to about 250° C., determined by differential scanning calorimetry (DSC) analysis from a second heating ramp at a heating rate of 10° C./min.

In some embodiments, the diacid component comprises from about 50 to 75 mole percent 4,4′-biphenyl dicarboxylic acid and from about 50 to 25 mole percent terephthalate, based on the total moles of the diacid component in the copolyester.

In some embodiments, the diol component comprises from about 25 to 45 mole percent CHDM and from about 75 to 55 mole percent ethylene glycol, based on the total moles of the diol component in the copolyester, wherein the diacid component comprises from about 50 to 75 mole percent 4,4′-biphenyl dicarboxylic acid and from about 50 to 25 mole percent terephthalate, based on the total moles of the diacid component in the copolyester, and wherein the melting temperature is less than or equal to about 220° C.

In some embodiments, the diol component comprises from about 50 to 90 mole percent CHDM and from about 50 to 10 mole percent ethylene glycol, based on the total moles of the diol component in the copolyester, the diacid component comprises from about 50 to 75 mole percent 4,4′-biphenyl dicarboxylic acid and from about 50 to 25 mole percent terephthalate, based on the total moles of the diacid component in the copolyester, and the glass transition temperature is equal to or greater than about 120° C.

In some embodiments, the diol component comprises from about 50 to 80 mole percent CHDM and from about 50 to 20 mole percent ethylene glycol, based on the total moles of the diol component in the copolyester, the diacid component comprises from about 55 to 75 mole percent 4,4′-biphenyl dicarboxylic acid and from about 45 to 25 mole percent terephthalate, based on the total moles of the diacid component in the copolyester, the melting temperature is less than or equal to about 220° C., and the glass transition temperature is equal to or greater than about 120° C.

In some embodiments, the amorphous copolyester has an elongation at break of equal to or greater than about 80 percent determined according to ASTM D638; and/or a tensile strength of equal to or greater than about 50 MPa determined according to ASTM D638; and/or a tensile modulus of equal to or greater than about 1500 MPa determined according to ASTM D638; and/or a flexural strength of equal to or greater than about 75 MPa, determined according to ASTM D790; and/or a flexural modulus of equal to or greater than about 2200 MPa, determined according to ASTM D790; and/or a heat distortion temperature at 455 kPa of equal to or greater than about 75° C., determined according to ASTM D648; and/or a heat distortion temperature at 1.82 MPa of equal to or greater than about 65° C., determined according to ASTM D648; and/or a combination thereof.

In some embodiments of the invention, the copolyesters may be prepared by melt polymerization techniques including transesterification and polycondensation, in batch, semi-batch or continuous processes. The copolyesters are preferably prepared in a reactor equipped with a stirrer, an inert gas (e.g., nitrogen) inlet, a thermocouple, a distillation column connected to a water-cooled condenser, a water separator, and a vacuum connection tube. Any of the equipment and procedures disclosed in U.S. Pat. Nos. 4,093,603 and 5,681,918, incorporated by reference herein, may be adapted for implementing some embodiments of the present invention.

In some embodiments, polycondensation processes may include melt phase processes conducted with the introduction of an inert gas stream, such as nitrogen, to shift the equilibrium and advance to high molecular weight and/or vacuum melt phase polycondensation at temperatures above about 150° C. and pressures below about 130 Pa (1 mm Hg). The esterification conditions can include, in some embodiments of the invention, an esterification catalyst, such as, for example, sulfuric acid, a sulfonic acid, and so on, preferably in an amount from about 0.05 to 1.50 percent by weight of the reactants; optional stabilizers, such as, for example, phenolic antioxidants such as IRGANOX 1010 or phosphonite- and phosphite-type stabilizers such as tributylphosphite, preferably in an amount from 0 to 1 percent by weight of the reactants; a temperature which is gradually increased from about 130° C. in the initial reaction steps up to about 190 to 280° C. in the later steps, initially under normal pressure, then, when necessary, under reduced pressure at the end of each step, while maintaining these operating conditions until a copolyester with the desired properties is obtained. If desired, the degree of esterification may be monitored by measuring the amount of water formed and the properties of the copolyester, for example, viscosity, hydroxyl number, acid number, and so on.

In embodiments, the polymerization reaction to produce the copolyesters may be carried out in the presence of one or more esterification catalysts as mentioned above. Suitable catalysts may also include those disclosed in U.S. Pat. Nos. 4,025,492, 4,136,089, 4,176,224, 4,238,593, and 4,208,527, which are hereby incorporated herein by reference. Suitable catalyst systems may include compounds of Ti, Ti/P, Mn/Ti/Co/P, Mn/Ti/P, Zn/Ti/Co/P, Zn/Al, Sb (e.g., Sb₂O₃), Sn (e.g., dibutyltin oxide, dibutyltin dilaurate, n-butyltin trioctoate) and so on. When cobalt is not used in the polycondensation, copolymerizable toners may be incorporated into the copolyesters to control the color of these copolyesters so that they are suitable for the intended applications where color may be an important property. In addition to the catalysts and toners, other additives, such as antioxidants, dyes, reheat agents, etc. may be used during the copolyesterification, or may be added after formation of the polymer.

In embodiments, the copolyesters may include conventional additives including pigments, colorants, stabilizers, antioxidants, extrusion aids, slip agents, carbon black, flame retardants and mixtures thereof. In embodiments, the copolyester may be combined or blended with one or more modifiers and/or blend polymers including polyamides; e.g., NYLON 6,6® (DuPont), poly(ether-imides), polyphenylene oxides, e.g., poly(2,6-dimethylphenylene oxide), poly(phenylene oxide)/polystyrene blends; e.g., NORYL® (GE), other polyesters, polyphenylene sulfides, polyphenylene sulfide/sulfones, poly(ester-carbonates), polycarbonates; e.g., Lexan® (GE), polysulfones, polysulfone ethers, poly(ether-ketones), combinations thereof, and the like.

Any of the copolyesters and compositions described herein may be used in the preparation of molded products in any molding process, including but not limited to, injection molding, gas-assisted injection molding, extrusion blow molding, injection blow molding, injection stretch blow molding, compression molding, rotational molding, foam molding, thermoforming, sheet extrusion, and profile extrusion. The molding processes are well known to those of ordinary skill in the art. The polyester compositions described above may also be used in the preparation of nonwoven fabrics and fibers. In embodiments, a shaped article such as an extruded profile or an extruded or injection molded article comprises one or more copolyesters according to one or more embodiments disclosed herein. Accordingly, in embodiments, copolyesters according to the instant invention can be molded and extruded using conventional melt processing techniques to produce a shaped article. Such articles may be transparent. The shaped articles manufactured from the copolyesters according to embodiments disclosed herein exhibit improved properties as shown in the examples below.

Shaped articles comprising one or more embodiments of the polymers disclosed herein may be produced using thermoplastic processing procedures such as injection molding, calendaring, extrusion, blow molding, extrusion blow molding, rotational molding, and so on. The amorphous and/or semicrystalline copolyesters according to some embodiments of the present invention exhibit improved stability at various melt temperatures. In the conversion of the copolyesters into shaped articles, the moisture content of copolyesters according to some embodiments of the present invention may be reduced to less than about 0.02 percent prior to melt processing.

In some embodiments according to the present invention, the glass transition temperature, and/or the morphology of the copolyester, and/or other properties can be controlled by selecting the amounts of the 4,4′BB, terephthalic acid (relative to terephthalate), and/or alicyclic polyhydroxyl compound, e.g., CHDM (relative to the alkylene diol). In some embodiments, increasing the relative amount(s) of the 4,4′BB and/or to a lesser extent the alicyclic polyhydroxyl compound, increases the glass transition temperature; and at the same time, increasing the relative amount of the 4,4′BB can increase the degree of crystallinity, whereas increasing the relative amount of the alicyclic polyhydroxyl compound and/or the NPG tends to decrease the degree of crystallinity. In this manner, the glass transition temperature and degree of crystallinity can be balanced as desired.

For example, in a copolyester having amounts of 4,4′BB that would otherwise obtain a semicrystalline morphology, the morphology can be changed to essentially amorphous by increasing the alicyclic polyhydroxyl compound and/or the NPG, i.e., in some embodiments, the presence of enough of the alicyclic polyhydroxyl compound and/or the NPG can reduce the crystallinity below 5 percent and/or to a level where the copolyester is otherwise essentially amorphous. Meanwhile, while the level of the 4,4′BB can work at cross-purposes to increase the degree of crystallinity, it also has the effect in some embodiments of increasing the Tg.

For example, we have found that the level(s) of the alicyclic polyhydroxyl compound and/or the NPG can facilitate an essentially amorphous morphology with a relatively higher Tg at high levels of the 4,4′BB that would otherwise obtain a semicrystalline morphology.

In some embodiments of the method according to the present invention, the contacting comprises melt transesterification and polycondensation for step polymerization of the diacid and diol components.

In some embodiments of the invention, the method comprises contacting (i) a diol component comprising CHDM and an alkylene diol selected from ethylene glycol, 1,3-propanediol, 1,4-butanediol, 1,6-hexanediol, NPG and combinations thereof, with (ii) a diacid component comprising 4,4′-biphenyl dicarboxylic acid or ester producing equivalent thereof and terephthalic acid or ester producing equivalent thereof, in the presence of (iii) a catalyst; and forming a copolyester comprising the alkylene diol, CHDM, 4,4′-biphenyl dicarboxylic acid and terephthalate.

In some embodiments of the method, the alkylene diol, a proportion of the CHDM in the diol component, and a proportion of the 4,4′-biphenyl dicarboxylic acid or ester producing equivalent thereof in the diacid component, are selected wherein the copolyester comprises an essentially amorphous morphology; and a glass transition temperature equal to or greater than about 110° C., determined by differential scanning calorimetry (DSC) analysis from a second heating ramp at a heating rate of 10° C./min.

In some embodiments of the method, the alkylene diol, a proportion of the CHDM in the diol component, and a proportion of the 4,4′-biphenyl dicarboxylic acid or ester producing equivalent thereof in the diacid component, are selected wherein the copolyester comprises: a semicrystalline morphology; a melting temperature less than or equal to about 240° C. determined by differential scanning calorimetry (DSC) analysis from a second heating ramp at a heating rate of 10° C./min; and a glass transition temperature equal to or greater than about 110° C., determined by DSC analysis from a second heating ramp at a heating rate of 10° C./min.

In some embodiments of the invention, a method to control the morphology, glass transition temperature, melting temperature and/or toughness of a copolyester, comprises: contacting (i) a diacid component comprising from about 10 to 90 mole percent 4,4′-biphenyl dicarboxylic acid or ester producing equivalent thereof, from about 10 to 90 mole percent terephthalic acid or ester producing equivalent thereof, based on the total moles of the diacid component in the copolyester, with (ii) a diol component comprising from about 10 to 90 mole percent CHDM and from about 10 to 90 mole percent alkylene diol comprising ethylene glycol, 1,3-propanediol, 1,4-butanediol, 1,6-hexanediol, NPG or the combination thereof, based on the total moles of the diol component in the copolyester, in the presence of (iii) a catalyst; and selecting a proportion of the CHDM in the diol component, a proportion of the 4,4′-biphenyl dicarboxylic acid or ester producing equivalent thereof in the diacid component, and a proportion of the multifunctional carboxylic acid or ester producing equivalent thereof in total repeating units, to produce a copolyester comprising: an essentially amorphous or a semicrystalline morphology; a glass transition temperature within a selected range equal to or greater than about 110° C., determined by differential scanning calorimetry (DSC) analysis from a second heating ramp at a heating rate of 10° C./min; and where the morphology is semicrystalline, a melting temperature less than about 240° C., determined by DSC analysis from a second heating ramp at a heating rate of 10° C./min.

In some embodiments of the method, the diol component comprises from about 20 to 80 mole percent CHDM; the diacid component comprises from about 50 to 80 mole percent 4,4′-biphenyl dicarboxylic acid; and the morphology is essentially amorphous.

In some embodiments of the method to produce the amorphous copolyester, the diol component comprises from about 30 to 70 mole percent CHDM; the diacid component comprises from about 60 to 80 mole percent 4,4′-biphenyl dicarboxylic acid; and the glass transition temperature is equal to or greater than about 115° C., determined by DSC analysis from a second heating ramp at a heating rate of 10° C./min.

In some embodiments of the method to produce the amorphous copolyester, the diol component comprises from about 40 to 80 mole percent CHDM and from about 20 to 60 mole percent alkylene diol, based on the total moles of the diol component in the copolyester; the diacid component comprises from about 50 to 75 mole percent 4,4′-biphenyl dicarboxylic acid and from about 25 to 50 mole percent terephthalate, based on the total moles of the diacid component in the copolyester; and the glass transition temperature is equal to or greater than about 115° C., determined by DSC analysis from a second heating ramp at a heating rate of 10° C./min.

In some embodiments of the method to produce the amorphous copolyester, the diol component comprises from about 40 to 80 mole percent CHDM and from about 20 to 60 mole percent NPG, based on the total moles of the diol component in the copolyester; the diacid component comprises from about 50 to 75 mole percent 4,4′-biphenyl dicarboxylic acid and from about 25 to 50 mole percent terephthalate, based on the total moles of the diacid component in the copolyester; and the glass transition temperature is equal to or greater than about 115° C., determined by DSC analysis from a second heating ramp at a heating rate of 10° C./min.

In some embodiments of the method to produce the amorphous copolyester, the copolyester comprises: an elongation at break of equal to or greater than about 80 percent determined according to ASTM D638; and/or a tensile strength of equal to or greater than about 50 MPa determined according to ASTM D638; and/or a tensile modulus of equal to or greater than about 1500 MPa determined according to ASTM D638; and/or a flexural strength of equal to or greater than about 75 MPa, determined according to ASTM D790; and/or a flexural modulus of equal to or greater than about 2200 MPa, determined according to ASTM D790; and/or a heat distortion temperature at 455 kPa of equal to or greater than about 75° C., determined according to ASTM D648; and/or a heat distortion temperature at 1.82 MPa of equal to or greater than about 65° C., determined according to ASTM D648; and/or an oxygen permeability less than or equal to about 4, or less than or equal to about 2.5, or less than or equal to about 2, or less than or equal to about 1.5, or less than or equal to about 1, or less than or equal to about 0.8, or less than or equal to about 0.7, or less than or equal to about 0.6, or less than or equal to about 0.5, or less than or equal to about 0.4, or less than or equal to about 0.3 cm³-cm/m²-atm-day; and/or a combination thereof.

In some embodiments of the method, the morphology is semicrystalline; the diol component comprises from about 10 to 90 mole percent CHDM and from about 10 to 90 mole percent of an alkylene diol comprising ethylene glycol, 1,3-propanediol, 1,4-butanediol, 1,6-hexanediol, NPG, or a combination thereof, based on the total moles of the diol component in the polyester; the diacid component comprising from about 50 to 90 mole percent 4,4′-biphenyl dicarboxylic acid and from about 10 to 50 mole percent terephthalate, based on the total moles of the diacid component in the polyester; the glass transition temperature is equal to or greater than about 110° C. determined by differential scanning calorimetry (DSC) analysis from a second heating ramp at a heating rate of 10° C./min; and the melting temperature is less than or equal to about 240° C., determined by differential scanning calorimetry (DSC) analysis from a second heating ramp at a heating rate of 10° C./min.

In some embodiments of the method to produce the semicrystalline copolyester, the diol component comprises from about 25 to 45 mole percent CHDM and from about 55 to 75 mole percent ethylene glycol, based on the total moles of the diol component in the copolyester; the diacid component comprises from about 50 to 75 mole percent 4,4′-biphenyl dicarboxylic acid and from about 25 to 50 mole percent terephthalate, based on the total moles of the diacid component in the copolyester; and the melting temperature is less than or equal to about 220° C. In some embodiments of the method to produce the semicrystalline copolyester, the diol component comprises from about 50 to 90 mole percent CHDM and from about 10 to 50 mole percent ethylene glycol, based on the total moles of the diol component in the copolyester; the diacid component comprises from about 50 to 75 mole percent 4,4′-BB and from about 25 to 50 mole percent terephthalate, based on the total moles of the diacid component in the copolyester; and the glass transition temperature is equal to or greater than about 120° C.

In some embodiments of the method to produce the semicrystalline copolyester, the diol component comprises from about 50 to 80 mole percent CHDM and from about 20 to 50 mole percent ethylene glycol, based on the total moles of the diol component in the copolyester; the diacid component comprises from about 55 to 75 mole percent 4,4′-biphenyl dicarboxylic acid and from about 25 to 45 mole percent terephthalate, based on the total moles of the diacid component in the copolyester; the glass transition temperature is equal to or greater than about 120° C.; and the melting temperature is less than or equal to about 220° C.

In some embodiments of the method to produce the semicrystalline copolyester, the copolyester comprises: an elongation at break of equal to or greater than about 80 percent determined according to ASTM D638; and/or a tensile strength of equal to or greater than about 50 MPa determined according to ASTM D638; and/or a tensile modulus of equal to or greater than about 1500 MPa determined according to ASTM D638; and/or a flexural strength of equal to or greater than about 75 MPa, determined according to ASTM D790; and/or a flexural modulus of equal to or greater than about 2200 MPa, determined according to ASTM D790; and/or a heat distortion temperature at 455 kPa of equal to or greater than about 75° C., determined according to ASTM D648; and/or a heat distortion temperature at 1.82 MPa of equal to or greater than about 65° C., determined according to ASTM D648; and/or an oxygen permeability less than or equal to about 4, or less than or equal to about 2.5, or less than or equal to about 2, or less than or equal to about 1.5, or less than or equal to about 1, or less than or equal to about 0.8, or less than or equal to about 0.7, or less than or equal to about 0.6, or less than or equal to about 0.5, or less than or equal to about 0.4, or less than or equal to about 0.3 cm³-cm/m²-atm-day; and/or a combination thereof.

### Examples

In the following examples, dimethyl 4,4′-biphenyldicarboxylate (4,4′BB) was supplied by EXXONMOBIL and used as received. Ethylene glycol (EG) was purchased from SIGMA-ALDRICH (≥99%) and used as received. 1,4-Cyclohexanedimethanol (CHDM) with a 30:70 ratio of cis:trans was purchased from SIGMA-ALDRICH (mixture of cis and trans, ≥99%) and used as received. Dimethyl terephthalate (DMT) (≥99%) was purchased from Sigma-Aldrich. 2,2-Dimethyl-1,3-propanediol (neopentylglycol or NPG, 99%) was obtained from a commercial source and used as received. Titanium (IV) butoxide (97%) was purchased from SIGMA-ALDRICH, and 0.02-0.06 g/mL titanium solutions in anhydrous 1-butanol were prepared. All solvents, nitrogen gas (Praxair, 99.999%), oxygen gas (Airgas, 100%) and other gases were obtained from commercial sources and used as received. Dichloroacetic acid (≥99%) was purchased from Acros Organics. All other solvents were obtained from Spectrum. In the following examples, the DMT-BB copolyester copolymers are named according to a shorthand notation, wherein the name indicates the relative molar proportions of the various comonomers present therein. Polyester copolymers comprising DMT named using the prefix “T”, followed by the mol % of the comonomer ester. The sum of the mol % of the DMT and the comonomer ester is 100. For example, a 60 mol % DMT with 40% 4,4′BB diesters and 100% EG diol content is named as T-40-4,4′BB-EG. In embodiments comprising multiple diols, the mol % of one of the diols is indicated. For example, a copolymer comprising 65 mol % DMT with 35% 4,4′BB and 65% EG with 35% CHDM is referred to as T-35-4,4′BB-EG-35-CHDM. Consistent with the above nomenclature system, copolymers comprising 100% 4,4′BB with 100% EG are referred to as 4,4′BB-EG. An entire class of embodiments may be referred to herein by replacing the mol % of the minor diester monomer with variable “x” for the diacid component and variable “y” for the diol component. Accordingly, the copolymer class or family referred to as T-x-4,4′BB-EG-y-CHDM refers to copolymers comprising (100-x %) DMT, x % 4,4′BB, (100-y %) EG, and y % CHDM, wherein x and y are from greater than zero to less than 100.

The scale of the copolymer synthesis may be indicated, where relevant, by a suffix following the copolymer notation. For example, a copolymer produced on a 20-30 g scale may be followed by “(20-30 g)” and a copolymer produced on a 100-150 g scale by “(100-150 g)”.

Synthesis of Poly(DMT-co-4,4′BB)-EG (T-x-4,4′BB-EG, 20-30 g Scale):

The synthesis of a 60 mol % DMT, 40 mol % 4,4′BB is presented as an example here. Reactions were conducted in a dry 100 mL round-bottomed flask equipped with an overhead stirrer, nitrogen inlet, and distillation apparatus. As one example for T-40-4,4′BB, EG (12.4 g, 2 molar equivalents), DMT (11.65 g, 0.6 molar equivalents) and 4,4′BB (10.65 g, 0.4 molar equivalents) were charged to the flask. Other T-x-4,4′BB-EG syntheses were conducted using similar reactant ratios and procedures. Titanium butoxide solution (40 ppm of Ti) was injected into the flask in an amount for the theoretical yield, to catalyze the reaction. Degassing with vacuum and purging with nitrogen three times allowed the reaction to proceed oxygen free. The flask was submerged in a metal bath and the reaction proceeded at 180° C. for 1 h, 200° C. for 1 h, 220° C. for 2 h, all under constant stirring at 200 rpm and nitrogen purge. The bath was again heated up to 280° C. in 15 to 20 minutes, and vacuum slowly applied during the course of 1 hour until equilibrium was reached at 13-40 Pa (0.1-0.3 mm Hg), while the overhead stirrer was operated at a slow motor speed of 30-40 rpm to minimize polymer wrapping on the metal rod. The resulting polymer was removed from the flask, washed with deionized water and vacuum dried at 10-20° C. above its glass transition temperature.

Synthesis of Poly(DMT-co-4,4′BB)-(EG-co-CHDM) (100-150 g Scale):

All polymers were synthesized using the indicated molar equivalents and reaction equipment and conditions shown in the above syntheses of T-x-4,4′BB-EG, except that a 250 mL round bottom flask was used and vacuum was applied during the course of 1.25 h until a pressure of 27-54 Pa (0.2-0.4 mmHg) was achieved. The syntheses differed from the above example in that when a target ratio of EG:CHDM of 65:35 was selected, a molar ratio of 1.3 molar equivalents of EG was used with 0.35 molar equivalents of CHDM; and when a target ratio of EG:CHDM of 35:65 was selected, a molar ratio of 0.7 molar equivalents of EG was used with 0.65 molar equivalents of CHDM.

Synthesis of Poly(DMT-co-4,4′BB)NPG-co-CHDM) (100-150 g Scale):

All polymers were synthesized using the indicated molar equivalents and reaction equipment and conditions shown in the above syntheses of T-x-4,4′BB-EG, except that a 250 mL round bottom flask was used and vacuum was applied during the course of 1.25 h until a pressure of 27-54 Pa (0.2-0.4 mmHg) was achieved. The syntheses differed from the above example in that when a target ratio of NPG:CHDM of 35:65 was selected, a molar ratio of 0.525 molar equivalents of NPG was used with 0.65 molar equivalents of CHDM.

Synthesis of 50-T-50-3,4′BB-50-EG-50-CHDM Copolyester (20 g Scale):

The polymerization was performed in a dry 100 mL round bottom flask equipped with an overhead stirrer, a distillation arm and a nitrogen inlet. CHDM (5.58 g, 0.53 mol. eq.), EG (3.54 g, 0.75 mol. eq.), DMT (7.16 g, 0.5 mol. eq.) and 3,4′BB (9.96 g, 0.5 mol. eq.) were charged into the flask along with titanium butoxide solution (40 ppm Ti to the theoretical yield). Reactions were degassed with vacuum and purged with nitrogen three times to remove oxygen. The reaction flask was submerged in a metal bath and stirred at 200° C. for 1 h, then 210° C. for 1 h, then 220° C. for 1 h, then 280° C. for 1 h, all while continually purging with nitrogen and stirring at 250 rpm. Vacuum was then slowly applied over the course of one hour until a pressure of 0.1-0.3 mmHg was reached and the stirring speed was reduced to 30-40 rpm. The polymer was then removed from the flask, rinsed with DI water and vacuum dried overnight at 10-20° C. above the polymer glass transition temperature. Final polymer was clear and amorphous. Analysis with ¹H NMR determined the final composition of the copolyester at 52% DMT; 48% 3,4′BB; 49% EG and 51% CHDM. Inherent viscosity was measured at 0.77 dL/g. Differential scanning calorimetry showed the copolyester to be completely amorphous with a T_{g} at 99° C. Thermogravimetric analysis showed 5% weight loss at 396° C.

Compression Molding of Copolyesters:

As described above, polymers were melt pressed between two aluminum plates, layered with KAPTON® films using a PHI Q-230H manual hydraulic compression press. Aluminum shims were inserted to control the film thickness. REXCO PARTALL® power glossy liquid mold release agent was applied to the KAPTON® films to facilitate release of the polyesters. Samples were heated at 275° C. for 1 minute for amorphous polyesters or 3 minutes for semi-crystalline polyesters before the top stainless steel plate was added. The plates were then centered in the press and closed until there was no visible gap between plates. After two more minutes of heating at 275° C., four 30-second press-release-press cycles were completed with the first two presses utilizing 44.5 kN (5 tons) force and the last two presses utilizing 89 kN (10 tons) force. After the final press, the aluminum plates were immediately submersed in an ice water bath to quench cool the samples. Films were then isolated and dried in a vacuum oven at 40° C. overnight before further characterizations.

Biaxial Stretching of (Co)Polyester Films:

Compression molded films (0.254 mm (10 mil)) were subjected to biaxial stretching using a BRUECKNER KARO IV laboratory stretching machine. Films were sized into 84 mm by 84 mm (3.3 in. by 3.3 in.) square and clamped firmly by 20 pressurized clips. The polymer film was drawn simultaneously in both machine direction (MD) and transverse direction (TD) at a speed of 150%/s to a final draw ratio of 3×3.

NMR Analysis:

¹H NMR spectra were acquired on a BRUKER AVANCE II 500 MHz instrument with a minimum of 32 scans at 23° C. Samples were dissolved (ca. 50 mg/mL) in mixtures of TFA-d and CDCl₃ (approximately 5:95 v/v) and chemical shifts are measured with respect to internal tetramethylsilane (TMS). ¹H NMR confirmed 4,4′-bibenzoate and terephthalate incorporation and the actual compositions determined by ¹H NMR were within 0-2 mol % of the target ratios. The by-product, diethylene glycol (DEG), also calculated based on NMR spectra, was present at molar 2-3 mol %. Scaling up from 20-30 g to 150 g did not affect the comonomer composition or the DEG levels. Quantitative ¹³C NMR confirmed that melt-phase polymerization produced completely random copolymers.

Viscosity Analysis:

Inherent viscosities were measured in 0.5% (g/dL) dichloroacetic acid solution at 25° C. by means of a CANNON TYPE B glass capillary viscometer, adapted from ASTM method D4603. Inherent viscosity at 0.5 g/dL dichloroacetic acid solution was used to calculate intrinsic viscosity according to the method outlined in Ma et al. Embodiments of the copolyesters disclosed herein achieved high inherent viscosities in the range of 0.8-0.9 dL/g, which corresponds to viscosity-average molecular weight of 26,600-30,700 g/mol, based on the empirical Mark-Houwink equation in which k=1.7×10⁻⁴ and α=0.83.

Thermogravimetric Analysis:

Thermogravimetric analysis (TGA) of polymer samples (˜10 mg) were analyzed using TGA Q500 (TA Instruments, New Castle, Del.) at a heating rate of 10° C./min from 30° C. to 600° C. under nitrogen. All of the synthesized materials were thermally stable up to 360-400° C. TGA thermograms of T-x-3,4′BB-EG copolyesters showed that the degradation temperature (Td, 5 wt %) did not increase with the replacement of terephthalate units by the 4,4′ biphenyl units in the T-x-4,4′BB-EG copolyesters.

Differential Scanning Calorimetry:

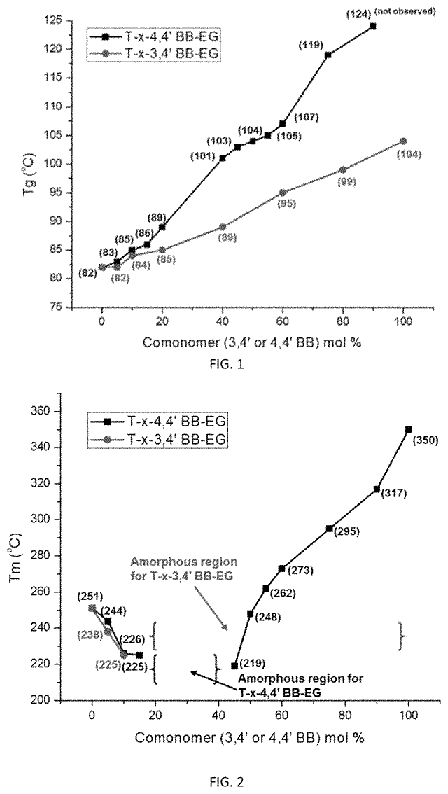

Differential scanning calorimetry (DSC) was conducted using Q2000 (TA Instruments, New Castle, Del.), calibrated with indium and tin standards. A small piece of polymer film (5 mg) was analyzed in a TZERO™ pan under a nitrogen atmosphere with heating and cooling rates of 10° C./min. The sample was held at temperature for 3 min between heating and cooling scans. Glass transition temperatures were measured as the midpoint of the transition in the second heating ramp. As shown in FIGS. 1 and 2, DSC analysis revealed thermal behaviors including glass transition temperature (T_{g}) and melt temperature (peak value, Tm). Values reported in parentheses were in the unit of ° C.

As seen in these data (FIG. 2), copolyesters with 4,4′BB incorporation greater than 15 mol % and less than 45 mol % showed no crystallinity, e.g., from 20 to 35 mol % as indicated by the bracketed amorphous region; however, once the 4,4′BB content reached around 55 mol %, the polyester had a Tm similar to PET, but a much more rapid crystallization rate. At 100 mol % 4,4′BB, the 4,4′BB-EG polyester was highly crystalline: no T_{g} could be detected.

For the copolyesters incorporating the kinked 3,4′BB comonomer units, among all T-x-3,4′BB-EG copolyesters, only those polymers with 10% 3,4′BB incorporation or less remained semicrystalline, with a lower melting temperature (≤238° C.; FIG. 1), slower tendency to crystallize (ΔT 85° C.) and much lower degree of crystallinity (≤4.3%) than the PET control. PET-3,4′BB's above 10 mol % of 3,4′BB were amorphous, e.g., at 20 mol % and more as shown in FIG. 2. The 3,4′BB-EG homopolymer, was also amorphous and displayed a T_{g} of 104° C.

Tensile Testing:

Dogbone samples were injection molded for tensile testing on a BOY XS injection molding machine, with mold temperature of 7° C. (45° F.); barrel temperatures: 275° C.-290° C.; holding pressure: 6.9 MPa (1000 psi); and cycle time: ˜60 sec and were used for measurements without additional conditioning. Tensile testing was conducted on an INSTRON 5500R with a crosshead motion rate of 10 mm/min and an initial grip separation of 25.4±2.0 mm, and on an MTS Model No. 4204 with a 1 kN load cell and a crosshead motion rate of 5 mm/min (before 5% strain) and 10 mm/min (after 5% strain) with an initial grip-to-grip separation of 25.4±2.0 mm. Tensile modulus was estimated by crosshead displacement, but would likely be lower possibly due to sample slippage, which artificially increased the measured strain. In ASTM D638, an extensometer is generally used in the initial portion of the test to determine strain. An Epsilon 3442 miniature extensometer was therefore attached to more accurately measure the tensile modulus.

Table 1A below lists the tensile modulus, yield stress, and elongation to break determined without extensometer, and tensile modulus with the micro-extensometer for an average of 3-5 measurements. The moduli of samples with a fast crystallization rate, e.g. T-40-4,4′BB-EG, T-55-4,4′BB-EG, and T-40-3,4′BB-EG were significantly higher and broke easily in the crystalline domain (opaque sections). During the stretching experiments, these samples actually broke far beyond the grip area, therefore the results were not reported. In general, with 4,4′BB incorporation, the copolyesters maintained high modulus and strength.

Flexural Testing:

Un-notched Izod bars, also produced by micro-injection molding, were subject to flexural and heat distortion testing according to ASTM D790. Flexural testing was conducted on an MTS Model No. 4204 with a 1 kN load cell and a crosshead motion rate of 1.2-1.4 mm/min in accordance with ASTM D790 specifications. The flexural strength was determined at the maximum stress within the first 5% strain or at the 5% strain if the stress continued to increase. Flexural testing afforded expected results in accordance with the tensile testing data, as seen in Table 1A. As shown in Table 1A, the flexural modulus is within 10% of the tensile modulus for each sample and the flexural strength is about 1.5× the tensile strength, which were expected.

Heat Distortion Testing:

The heat distortion temperature (HDT) is the temperature at which a plastic sample deforms under a specified load of 0.455 MPa or 1.82 MPa. Thermomechanical analysis was also performed using a 3-point bending geometry by dynamic mechanical analysis (DMA). DMA was conducted on a TA Instruments Q800 dynamic mechanical analyzer in tension and 3-point bending mode. Tension was conducted at a frequency of 1 Hz and an oscillatory amplitude of 15 μm. The temperature ramp was 2° C./min. Controlled force 3-point bending was conducted at a static force set to equal 0.455 MPa or 1.82 MPa stress in accordance with ASTM D648. Polymers were compression molded using a 400 μm (16 mil) stainless steel shim. As shown in Table 1, the HDT increased with more 4,4′BB incorporation, in accordance to T_{g} trends. Again, the HDT could be significantly influenced by the crystallization rate, in this case, highly crystalline T-40-4,4′BB-EG and T-55-4,4′BB-EG derived higher HDT values than other amorphous samples.

TABLE 1A
Mechanical and thermal properties of diacid modified EG copolymers

| | | | | T-10- | T-40- | T-55- | T-10- | T-35- | T-40- |
|---|---|---|---|---|---|---|---|---|---|
| Copolymer | C1 | C2 | C3 | 4,4′BB | 4,4′BB | 4,4′BB | 3,4′BB | 4,4′BB | 3,4′BB |
| Naphthalate | | | 100 | | | | | | |
| (mol %) | | | | | | | | | |
| Terephthalate | 100 | 100 | | 90 | 60 | 45 | 90 | 65 | 60 |
| (mol %) | | | | | | | | | |
| 4,4′BB | | | | 10 | 40 | 55 | | 35 | |
| (mol %) | | | | | | | | | |
| 3,4′BB | | | | | | | 10 | | 40 |
| (mol %) | | | | | | | | | |
| EG (mol %) | 100 | 100 | 100 | 100 | 100 | 100 | 100 | 100 | 100 |

Morphology

| | | | | | | | | |
|---|---|---|---|---|---|---|---|---|
| SC | SC | SC | SC | SC | SC | SC | A | A |

Mechanical Properties

| | | | | | | | | | |
|---|---|---|---|---|---|---|---|---|---|
| Ten. strength | 53.4 ± 1.7 | 55.7 ± 2.0 | 77.2 ± 1.0 | 55.0 ± 0.3 | NR | NR | 59.5 ± 0.5 | 52.9 ± 0.3 | 65.0 ± 0.9 |
| (MPa) | | | | | | | | | |
| TS at Break | 61.2 ± 1.4 | 52.7 ± 0.4 | 59.5 ± 6.2 | 54.1 ± 4.3 | NR | NR | 56.3 ± 1.6 | | 51.0 ± 6.4 |
| (MPa) | | | | | | | | | |
| Tensile mod. | 1600 ± 93 | 1576 ± 41 | 1734 ± 28 | 1608 ± 20 | 2660 ± 46 | 3580 ± 350 | 1655 ± 28 | 1584 ± 74 | 1763 ± 73 |
| (MPa)^{a} | | | | | | | | | |
| Tensile mod. | 2283 ± 28 | 2226 ± 222 | 2229 ± 48 | 2131 ± 51 | 4834 | 7540 | 2215 ± 95 | 2101 ± 51 | 2376 ± 113 |
| (MPa)^{b} | | | | | | | | | |
| Elongation | 387 ± 23 | 316 ± 4 | 130 ± 26 | 288 ± 24 | NR | NR | 332 ± 17 | 89 ± 13 | 257 ± 43 |
| to break (%) | | | | | | | | | |
| Flexural | 2393 ± 17 | 2412 | 2309 ± 18 | 2255 ± 32 | 3618 | 3243 | 2444 ± 32 | 2420* | 2576 ± 44 |
| mod. (MPa) | | | | | | | | 2269** | |
| FS (MPa) | 83.4 ± 1.5 | 84 | 94.1 ± 1.5 | 77.6 ± 0.4 | 90 | 84.4 | 86.8 ± 0.9 | 77.4*, | 95.0 ± 0.5 |
| | | | | | | | | 76.6** | |

Thermal Properties

| | | | | | | | | | |
|---|---|---|---|---|---|---|---|---|---|
| Tg (° C.) | 81 | 81 | 122 | 85 | 100 | 105 | 83 | 98 | 91 |
| Tm (° C.) | 252 | 252 | 265 | 228 | 216 | 262 | 228 | A | A |
| HDT @ | 63-166 | 66 | 95 | 70 | 92 | 99 | 68 | 80 | 75 |
| 0.455 MPa | | | | | | | | | |
| (° C.) | | | | | | | | | |
| HDT @ 1.82 | 60-93 | 60 | 73 | 64 | 69-92 | 61-90 | 62 | 67 | 67 |
| MPa (° C.) | | | | | | | | | |

C1 PET-418;
C2 Lab PET;
C3 Lab PEN;
TS tensile strength;
^{a}without extensometer;
^{b}with extensometer;
FS flexural strength;
NR = not reported;
*Flexural modulus or strength, more opaque sections;
**Flexural modulus or strength, less opaque sections;
A = amorphous, no melting point observed.

Effect of Sample Molding Conditions:

Table 1B shows how the mechanical properties of the polyesters are partially dependent on the method by which the material was processed. These samples were injection molded on a BOY XS injection molding machine as shown in Table 1B.

TABLE 1B
Mechanical properties of T-4,4′BB-EG copolymers

| | | |
|---|---|---|
| | T-40- | T-55- |
| Copolymer | 4,4′BB-EG | 4,4′BB-EG |

Injection Molding Conditions

| | | |
|---|---|---|
| Front Zone Temp (° C.) | 555 | 570 |
| Back Zone Temp (° C.) | 555 | 565 |
| Mold Temp (° C.) | 160 | 105 |
| Pressure Fill (psi) | 1200 | 1600 |
| Pressure Hold (psi) | 1000 | 1000 |
| Screw Speed (rpm) | Medium | Slow |

Mechanical Properties

| | | |
|---|---|---|
| Ten. strength (MPa) | 53.3 | 105.3 |
| TS at Break (MPa) | | |
| Tensile mod. (MPa)^{a} | | |
| Tensile mod. (MPa)^{b} | 2323 | 8680.4 |
| Elongation to break | 181 | 10.6 |
| (%) | | |
| Flexural mod. (MPa) | 2565 | 7811 |
| FS (MPa) | 78.8 | 132 |
| Notched Izod Impact | 0.88 | 0.46 |
| (23° C., J/cm) | | |

TS tensile strength;
^{a}without extensometer;
^{b}with extensometer;
NR = not reported.

TABLE 2
Permeability coefficients at RT, unoriented 76 micron (3 mil) films

| | Permeability | Literature Value^{a} | |
|---|---|---|---|
| | (cm³-cm/ | (cm³-cm/ | Permeability |
| Polymer | m²-atm-day) | m²-atm-day) | Rel. to C1 |
| C1 (PET-418) | 0.501 ± 0.011 | N/A | 1.00 |
| C2 (Lab PET) | 0.461 ± 0.001 | 0.469 ± 0.002 | 0.920 |
| C3 (Lab PEN) | 0.155 ± 0.005 | 0.157 ± 0.001 | 0.309 |
| T-10-4,4′BB-EG | 0.515 ± 0.004 | 0.512 ± 0.004 | 1.03 |
| T-10-4,4′BB-EG | 0.309 ± 0.05 | N/A | 0.617 |
| (Biaxially oriented | | | |
| 110° C.) | | | |
| T-10-3,4′BB-EG | 0.467 ± 0.009 | 0.449 ± 0.008 | 0.932 |
| T-10-3,4′BB-EG | 0.294 ± 0.028 | N/A | 0.587 |
| (Biaxially oriented | | | |
| 110° C.) | | | |
| 3,4′BB-EG | 0.346 ± 0.030 | 0.390 ± 0.004 | 0.691 |

^{a}Polyakova et al., J. Polym. Sci., Part B Polym. Phys., 39(16): 1889-1899 (2001);
N/A not available.

Oxygen Permeability:

Oxygen flux measurements were obtained using a SYSTECH ILLINOIS 8001 oxygen permeation analyzer at RT and 0% relative humidity with an oxygen flow of 20 mL/min and a nitrogen flow of 10 mL/min, according to manufacturer procedures. Polymer films were compression molded using a 76 micron (3 mil) aluminum shim and the oxygen permeability was measured on the unoriented film. Polymer films were also biaxially oriented at ca. 25° C. above the polymer Tg, as described above. Notably, T-10-3,4′BB-EG, T-10-4,4′BB-EG and PEN, were stretched successfully and displayed characteristic strain hardening behavior. The permeability coefficients for various polyesters in unoriented films, and biaxially oriented T-10-3,4′BB-EG, are reported in Table 2.

T-x-4,4′BB-EG-y-CHDM and T-x-4,4′BB-NPG-y-CHDM Copolyesters:

As noted above and as seen in FIG. 1, the terephthalate-bibenzoate copolyesters T-x-4,4′BB-EG have an increasing Tg as the proportion of 4,4′BB increases, e.g., from 82° C. at 0 mol % (PET) up to 119° C. at 80 mol % 4,4′BB; however, these copolyesters are semicrystalline at both high (255 mol %) and low (≤15 mol %) 4,4′BB incorporation levels, and pass through a small, essentially amorphous window bracketing T-35(±)-4,4′BB-EG, e.g., about 20-50 mol % 4,4′BB. The highest Tg's in this window are barely greater than 100° C., but cannot be increased with increasing 4,4′BB while maintaining an amorphous morphology.

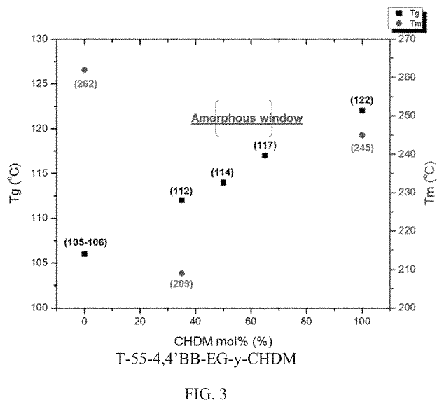

In the present series of copolyester syntheses, a 33:67 ratio of cis:trans isomers of CHDM was used to replace different amounts of the EG in the copolyester T-55-4,4′BB-EG, and characterized the resulting copolyester T-55-4,4′-EG-y-CHDM using 1H NMR and DSC. The NMR spectra indicated the cis/trans ratio of CHDM remained unchanged, while the actual amount of CHDM incorporated was 2-3 mol % lower than the targeted ratio, presumably due to early sublimation in the reaction melt. As shown in Table 3, and in FIG. 3, however, incorporating increasing amounts of CHDM into the T-55-4,4′BB-EG-y-CHDM system afforded a range of amorphous copolyesters with enhanced T_{g}'s. Surprisingly, the T-55-4,4′BB-EG-65-CHDM copolyester exhibited a T_{g} of 117° C., which was in in the same range as T-≥65-4,4′BB-EG (see FIG. 1). Higher levels of CHDM incorporation, on the other hand, unexpectedly obtained a semicrystalline morphology, indicating that there was also a window of amorphous morphology for CHDM in the T-55-4,4BB-EG-y-CHDM system between about 40 and 65 mol % CHDM.

Tensile data of the copolyester T-35-4,4′BB-EG indicated tough materials, with comparable modulus, tensile stress and elongation at break in the ranges of PET and PCTG (see Table 1).

TABLE 3
DSC data comparisons of T-(55-65)-
4,4′BB-(EG/NPG)-y-CHDM copolyesters

| | T_{g}, 2^{nd} melt | Tₘ, 2^{nd} melt | ΔHₘ, 2^{d} melt |
|---|---|---|---|
| Polyester | (° C.) | (° C.) | (J/g) |
| T-55-4,4′BB-EG | 105-106 | 262 | 28.5 |
| T-55-4,4′BB-EG-35-CHDM | 112 | 209 | 7.1 |
| T-55-4,4′BB-EG-50-CHDM | 114 | Amorphous | 0 |
| T-55-4,4′BB-EG-65-CHDM | 117 | Amorphous | 0 |
| T-55-4,4′BB-CHDM | 122 | 245 | 7.8 |
| T-60-4,4′BB-EG-65-CHDM | 119-120 | Amorphous | 0 |
| T-65-4,4′BB-EG-65-CHDM | 122 | 208 | 16.5 |
| T-65-4,4′BB-NPG-65-CHDM | 119 | Amorphous | 0 |

Amorphous T-60-4,4′BB-EG-65-CHDM Copolyester:

Further increasing the 4,4′BB level up to 60 mol % while keeping the CHDM:EG ratio unchanged, the material unexpectedly failed to show a Tc or a Tm under DSC analysis, indicative of an essentially amorphous morphology, and showed a T_{g} of 119-120° C. Accordingly, it is considered that replacing a portion of the EG diol component with CHDM unexpectedly results in shifting the upper end of the amorphous 4,4′BB window, so that higher levels of 4,4′BB that would not normally obtain semicrystalline morphology, can now be incorporated in an amorphous morphology. Furthermore, the Tg of the amorphous copolyesters T-(≥55)-4,4′BB-EG-y-CHDM in this shifted window can be substantially higher than the Tg of the corresponding copolyesters T-(≥55)-4,4′BB-EG without CHDM. These unexpected results demonstrate that T-x-4,4′BB aromatic copolyesters can serve as replacements for BPA PC in many applications requiring resistance to thermal flow.

Due to the incorporation of kinked 3,4′BB comonomer units, among all T-x-3,4′BB-EG copolyesters, only with less than 10% 3,4′BB incorporation the polymers remained semicrystalline with lower melting temperature (≤238° C.), slower tendency to crystalize (ΔT 85° C.) and much lower degree of crystallinity (≤4.3%) than the PET control. PET-3,4′BBs with 20 mol % and more of 3,4′BB were amorphous, and the T_{g} values were close to Fox equation predictions. The 3,4′BB-EG homopolymer, stayed amorphous and displayed a T_{g} of 104° C.

Amorphous T-65-4,4′BB-NPG-65-CHDM Copolyester:

When the 4,4′BB content was increased above 60 mol %, amorphous morphology could not be maintained in the resulting copolyester T-65-4,4′BB-EG-CHDM, suggesting a composition outside of the amorphous window. NPG was then used to replace the EG. A targeted ratio of T-65-4,4′BB-NPG-65-CHDM (resulting in an actual ratio: DMT/4,4′BB 34:66; NPG/CHDM 33:67, by ¹H NMR) yielded an amorphous copolyester with a glass transition of 119° C., as shown in Table 3.

Although only a few example embodiments have been described in detail above, those skilled in the art will readily appreciate that many modifications are possible in the example embodiments without materially departing from this invention. Accordingly, all such modifications are intended to be included within the scope of this invention as defined in the following claims. It is the express intention of the applicant not to invoke 35 U.S.C. § 112(f) for any limitations of any of the claims herein, except for those in which the claim expressly uses the words ‘means for’ together with an associated function and without any recitation of structure. The priority document is incorporated herein by reference.

1. A copolyester comprising:
a diol component comprising an alkylene diol and an alicyclic polyhydroxyl compound; and
a diacid component comprising terephthalate and one or a combination of 4,4′-biphenyl dicarboxylate and 3,4′-biphenyl dicarboxylate,
wherein the copolyester has an amorphous morphology.

2. The copolyester of claim 1, wherein:
the diol component comprises from about 10 to 90 mole percent 1,4-cyclohexanedimethanol, and from about 90 to 10 mole percent alkylene diol selected from the group consisting of ethylene glycol, 1,3-propanediol, 1,4-butanediol, 1,6-hexanediol, neopentyl glycol, and the combination thereof, based on the total moles of the diol component in the polyester; and
the diacid component comprises from about 10 to 90 mole percent 4,4′-biphenyl dicarboxylate, 3,4′-biphenyl dicarboxylate, or a combination thereof, and from about 90 to 10 mole percent terephthalate, based on the total moles of the diacid component in the copolyester.

3. The copolyester of claim 1, further comprising:
an average number molecular weight, Mn, of equal to or greater than about 5,000 g/mol and a polydispersity from about 1.75 to 3.5.

4. The copolyester of claim 1, comprising a glass transition temperature equal to or greater than about 105° C., determined by differential scanning calorimetry (DSC) analysis from a second heating ramp at a heating rate of 10° C./min.

5. The copolyester of claim 1, comprising an oxygen permeability less than or equal to about 4 cm³-cm/m²-atm-day.

6. The copolyester of claim 1, wherein:
the diol component comprises from about 10 to 90 mole percent 1,4-cyclohexanedimethanol and from about 90 to 10 mole percent of an alkylene diol comprising ethylene glycol, 1,3-propanediol, 1,4-butanediol, 1,6-hexanediol, neopentyl glycol, or a combination thereof, based on the total moles of the diol component in the polyester; and
the diacid component comprises from about 30 to 90 mole percent 4,4′-biphenyl dicarboxylate and from about 70 to 10 mole percent terephthalate, based on the total moles of the diacid component in the polyester;
the copolyester has a glass transition temperature equal to or greater than about 110° C. determined by differential scanning calorimetry (DSC) analysis from a second heating ramp at a heating rate of 10° C./min.

7. The copolyester of claim 6, wherein the diol component comprises from about 40 to 80 mole percent 1,4-cyclohexanedimethanol and from about 60 to 20 mole percent alkylene diol, based on the total moles of the diol component in the copolyester.

8. The copolyester of claim 6, wherein the diol component comprises from about 50 to 75 mole percent 1,4-cyclohexanedimethanol and from about 50 to 25 mole percent neopentyl glycol, based on the total moles of the diol component in the copolyester.

9. The copolyester of claim 6, wherein the glass transition temperature is equal to or greater than about 115° C.

10. (canceled)

11. The copolyester of claim 7, wherein the diacid component comprises from about 50 to 75 mole percent 4,4′-biphenyl dicarboxylate and from about 50 to 25 mole percent terephthalate, based on the total moles of the diacid component in the copolyester.

12-14. (canceled)

15. The copolyester of claim 1, wherein the copolyester has:
an elongation at break of equal to or greater than about 80 percent determined according to ASTM D638; and/or
a tensile strength of equal to or greater than about 50 MPa determined according to ASTM D638; and/or
a tensile modulus of equal to or greater than about 1500 MPa determined according to ASTM D638; and/or
a flexural strength of equal to or greater than about 75 MPa, determined according to ASTM D790; and/or
a flexural modulus of equal to or greater than about 2200 MPa, determined according to ASTM D790; and/or
a heat distortion temperature at 455 kPa of equal to or greater than about 75° C., determined according to ASTM D648; and/or
a heat distortion temperature at 1.82 MPa of equal to or greater than about 65° C., determined according to ASTM D648; and/or
a combination thereof.

16. A method, comprising:
contacting (i) a diol component comprising 1,4-cyclohexanedimethanol and an alkylene diol selected from ethylene glycol, 1,3-propanediol, 1,4-butanediol, 1,6-hexanediol, neopentyl glycol and combinations thereof, with (ii) a diacid component comprising 4,4′-biphenyl dicarboxylic acid or ester producing equivalent thereof, 3,4′-biphenyl dicarboxylic acid or ester producing equivalent thereof, or a combination thereof, and terephthalic acid or ester producing equivalent thereof, in the presence of (iii) a catalyst; and
forming an amorphous copolyester comprising the alkylene diol, 1,4-cyclohexanedimethanol, and 4,4′-biphenyl dicarboxylate, 3,4′-biphenyl dicarboxylate, or a combination thereof, and terephthalate.

17. The method of claim 16, wherein the alkylene diol, a proportion of the 1,4-cyclohexanedimethanol in the diol component, and a proportion of the 4,4′-biphenyl dicarboxylic acid or ester producing equivalent thereof, or 3,4′-biphenyl dicarboxylic acid or ester producing equivalent thereof, in the diacid component, are selected wherein the copolyester has
a glass transition temperature equal to or greater than about 110° C., determined by differential scanning calorimetry (DSC) analysis from a second heating ramp at a heating rate of 10° C./min.

18. (canceled)

19. A method to control the morphology, glass transition temperature, melting temperature and/or toughness of a copolyester, comprising:
contacting (i) a diacid component comprising from about 10 to 90 mole percent 4,4′-biphenyl dicarboxylic acid or ester producing equivalent thereof, and from about 90 to 10 mole percent terephthalic acid or ester producing equivalent thereof, based on the total moles of the diacid component in the copolyester, with (ii) a diol component comprising from about 10 to 90 mole percent 1,4-cyclohexanedimethanol and from about 90 to 10 mole percent alkylene diol comprising ethylene glycol, 1,3-propanediol, 1,4-butanediol, 1,6-hexanediol, neopentyl glycol or the combination thereof, based on the total moles of the diol component in the copolyester, and optionally a multifunctional carboxylic acid or ester producing equivalent thereof, in the presence of (iii) a catalyst; and
selecting a proportion of the 1,4-cyclohexanedimethanol in the diol component, and a proportion of the 4,4′-biphenyl dicarboxylic acid or ester producing equivalent thereof in the diacid component, and optionally a proportion of a multifunctional carboxylic acid or ester producing equivalent thereof, to produce a copolyester comprising:
an essentially amorphous morphology; and
a glass transition temperature within a selected range equal to or greater than about 110° C., determined by differential scanning calorimetry (DSC) analysis from a second heating ramp at a heating rate of 10° C./min.

20. The method of claim 19, wherein:
the diol component comprises from about 20 to 80 mole percent 1,4-cyclohexanedimethanol, based on the total moles of the diol component in the copolyester; and
the diacid component comprises from about 50 to 80 mole percent 4,4′-biphenyl dicarboxylic acid.

21. The method of claim 20, wherein:
the diol component comprises from about 30 to 70 mole percent 1,4-cyclohexanedimethanol based on the total moles of the diol component in the copolyester;
the diacid component comprises from about 60 to 80 mole percent 4,4′-biphenyl dicarboxylic acid or ester producing equivalent thereof; and
the glass transition temperature is equal to or greater than about 115° C., determined by DSC analysis from a second heating ramp at a heating rate of 10° C./min.

22. The method of claim 20, wherein:
the diol component comprises from about 40 to 80 mole percent 1,4-cyclohexanedimethanol and from about 60 to 20 mole percent alkylene diol, based on the total moles of the diol component in the copolyester;
the diacid component comprises from about 50 to 75 mole percent 4,4′-biphenyl dicarboxylic acid or ester producing equivalent thereof and from about 50 to 25 mole percent terephthalate or ester producing equivalent thereof, based on the total moles of the diacid component in the copolyester; and
the glass transition temperature is equal to or greater than about 115° C., determined by DSC analysis from a second heating ramp at a heating rate of 10° C./min.

23. The method of claim 20, wherein:
the diol component comprises from about 40 to 80 mole percent 1,4-cyclohexanedimethanol and from about 60 to 20 mole percent neopentyl glycol, based on the total moles of the diol component in the copolyester;
the diacid component comprises from about 50 to 75 mole percent 4,4′-biphenyl dicarboxylic acid or ester producing equivalent thereof and from about 50 to 25 mole percent terephthalate or ester producing equivalent thereof, based on the total moles of the diacid component in the copolyester; and
the glass transition temperature is equal to or greater than about 115° C., determined by DSC analysis from a second heating ramp at a heating rate of 10° C./min.

24-27. (canceled)

28. The method of claim 20, wherein the copolyester comprises:
an elongation at break of equal to or greater than about 80 percent determined according to ASTM D638; and/or
a tensile strength of equal to or greater than about 50 MPa determined according to ASTM D638; and/or
a tensile modulus of equal to or greater than about 1500 MPa determined according to ASTM D638; and/or
a flexural strength of equal to or greater than about 75 MPa, determined according to ASTM D790; and/or
a flexural modulus of equal to or greater than about 2200 MPa, determined according to ASTM D790; and/or
a heat distortion temperature at 455 kPa of equal to or greater than about 75° C., determined according to ASTM D648; and/or
a heat distortion temperature at 1.82 MPa of equal to or greater than about 65° C., determined according to ASTM D648; and/or
an oxygen permeability less than or equal to about 4 cm³-cm/m²-atm-day; and/or
a combination thereof.

29. The method of claim 18, further comprising forming the copolyester into a shaped article.

30. The copolyester of claim 1 formed into a shaped article.

31. The copolyester of claim 1, further comprising branching agent in an amount of from about 0.001 to 1 mole percent, based on the total moles of repeating units in the copolyester.

32. The copolyester of claim 1, wherein the diacid component comprises terephthalate and 3,4′-biphenyl dicarboxylate.

33. The method of claim 19, further comprising selecting a proportion of the multifunctional carboxylic acid or ester producing equivalent thereof in an amount of from about 0.001 to 1 mole percent, based on the total moles of repeating units in the copolyester.
